(19) United States
(12) Patent Application Publication
(10) Pub. No.: US 2018/0336002 A1
(43) Pub. Date: Nov. 22, 2018

(54) SOUND GENERATION DEVICE WITH PROXIMITY CONTROL FEATURES

(71) Applicant: Intel Corporation, Santa Clara, CA (US)

(72) Inventors: Carl C. Hansen, Aloha, OR (US); Duncan Glendinning, Chandler, AZ (US)

(73) Assignee: Intel Corporation, Santa Clara, CA (US)

(21) Appl. No.: 15/776,028

(22) PCT Filed: Dec. 15, 2015
(86) PCT No.: PCT/US2015/065712

§ 371 Date: May 14, 2018

(51) Int. Cl. G06F 3/16; F21V 33/00; H05B 33/08; F21V 23/04; H04R 1/02

(52) U.S. Cl. CPC G06F 3/165; F21V 33/0056; F21Y 2115/10; F21V 23/0471; H04R 1/028; H05B 33/0854

(57) ABSTRACT

The present disclosure pertains to a sound generation device with proximity control. In general, a device may include sound generation functionality that may be controlled based on proximity sensing. The device may be, for example, a lighting device including circuitry to generate sound based on audio data received from a source outside of the device. Sensing circuitry in the device may generate sensor data that indicates when a user is proximate to the device. Control circuitry in the device may then control the sound generation based on sensor data. Various operations in the device may be based on the sensor data indicating that a user is proximate to the device, the identity of the user, that a certain condition has occurred, etc.

### TECHNICAL FIELD

This disclosure relates to sound and light generation, and more particularly, to a sound and light generation device controlled in a variety of modes based on user proximity sensing.

### BACKGROUND

Electronic lighting is currently the focus of substantial technological development and advancement. For example, the desire for efficient, long life, flexible, etc. light sources (e.g., light bulbs, light fixtures within integrated electronic light sources, etc.) has shifted the focus from traditional incandescent lighting-based solutions to emerging lighting technologies like compact fluorescent lighting (CFL), lighting solutions employing light emitting diode (LED) technology, etc. The light sources resulting from this development are more efficient, have longer lives, are more flexible in terms of light output, are better for the environment, etc.

Moreover, since these emerging lighting devices often operate at cooler temperatures, utilize less power, generate less interference, etc. than traditional incandescent lighting-based solutions, these devices may be designed to incorporate features beyond simple illumination. For example, existing devices may incorporate sound generation technology (e.g., a speaker and supporting circuitry) into a light source (e.g., an LED light). These devices may employ a form factor that allows them to be inserted into an existing light socket for power, and may operate in a manner similar to a traditional light source. However, a user may further couple an audio source to the light via wireless communication such as Bluetooth so that the onboard speaker may generate sound (e.g., a TV or movie soundtrack, music, etc.). While the ability for a lighting device to generate sound may appear beneficial, there are some drawbacks. For example, these solutions are currently wasteful in that they may continue to stay connected to a device and generate sound regardless of whether there is actually a user listening (e.g., the user may be conducting a telephone call, may have left the room, etc.), the audio source may continue to send audio even after the user is out of range of the speaker, etc. While this may not substantially affect the lighting device, this type of operation may needlessly waste power if the audio source is power sensitive (e.g., a mobile device), cause the user to miss the audio playback when the audio source is out of speaker range, etc. There is also no way to organize sound generation so that the sound is generated corresponding to the current location of the user. In some instances particular users may be able to configure the sound generation device to product sound in a certain manner. If there are multiple users for the speaker feature, then the configuration may be modified whenever the speaker feature is utilized by different users.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example system including sound generation devices with proximity control features in accordance with at least one embodiment of the present disclosure;

FIG. 2 illustrates an example configuration for a device usable in accordance with at least one embodiment of the present disclosure;

FIG. 3 illustrates an example functionality that may be performed within a system including sound generation devices with proximity control features in accordance with at least one embodiment of the present disclosure; and

FIG. 4 illustrates example operations controlling sound generation in a device based on proximity in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

The present disclosure pertains to a sound generation device with proximity control. In general, a device may include sound generation functionality that may be controlled based on proximity sensing. The device may be, for example, a lighting device including circuitry to generate sound based on audio data received from a source outside of the device. Sensing circuitry in the device may generate sensor data that indicates when a user is proximate to the device. Control circuitry in the device may then control the sound generation based on sensor data. The device may be able to interact with other devices in a group and may control sound generation within the group. The device may also be able to determine the identity of a user sensed in proximity to the device, and may configure itself, or devices in the group, based on the user identification. The device may further be able to determine if a condition has been satisfied indicating that transmission and/or playback of the audio data by the source should be paused, and may resume transmission and/or playback after it is determined that a further condition has been satisfied. For example, the transmission and/or playback of the audio data may be paused while a user transitions from one area corresponding to the device (e.g., a room, a vehicle, etc.) to another, while the user is executing an activity (e.g., a call), etc.

In at least one embodiment, an example device may comprise at least communication circuitry, audio circuitry, sensing circuitry and control circuitry. The communication circuitry may be to receive at least audio data. The audio circuitry may be to generate sound based on the received audio data. The sensing circuitry may be to generate sensor data based on proximity sensing. The control circuitry may be to control at least the audio circuitry based on the sensor data.

In at least one embodiment, the device may further comprise, for example, lighting circuitry to generate light, the lighting circuitry also being controlled by the control circuitry. The device may further comprise a connector for electrically coupling the device to a light socket to receive power for operating the device. The control circuitry may be to cause the audio circuitry to generate the sound when the sensor data indicates that the user is proximate to the device.

In at least one embodiment, the control circuitry may be to cause at least the communication circuitry to interact with other devices to cause the other devices to generate the sound. For example, the device and other devices may constitute a group of devices, all of the devices in the group being caused to generate the sound when at least one of the devices determines that the user is proximate. The control circuitry may be to at least one of cause the audio circuitry to discontinue sound generation when the sensor data indicates that the user is no longer proximate to the device or cause the communication circuitry to interact with the other devices to cause the other devices to discontinue sound generation.

In at least one embodiment, the control circuitry may be to determine an identity of the user and configure at least the audio circuitry based on the determined identity of the user. The control circuitry may be to cause the communication circuitry to interact with a source of the audio data to cause the source to pause at least one of playback or transmission of the audio data based on a first condition being satisfied. The control circuitry may then be to cause the communication circuitry to interact with the source to cause the source to resume at least one of the paused playback or transmission of the audio data based on a second condition being satisfied. The first condition may include, for example, the user leaving an area corresponding to the device and the second condition may include the user entering the area. Alternatively, the first condition may include the user initiating an activity on a source device and the second condition may include the user concluding the activity. Consistent with the present disclosure, a method for controlling sound generation in a device based on proximity may comprise, for example, sensing a user in proximity to a device, generating sensor data based on the sensing, receiving at least audio data in the device, enabling sound generation in the device based at least on the sensor data and causing the device to generate sound based at least one the audio data.

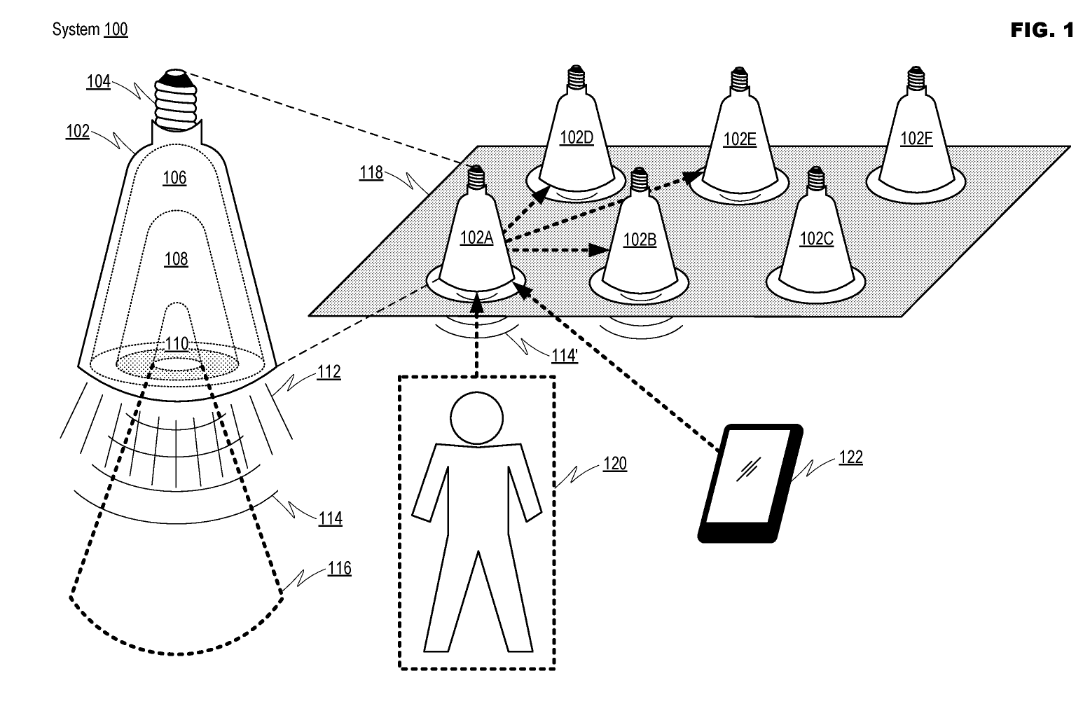

FIG. 1 illustrates an example system including sound generation devices with proximity control features in accordance with at least one embodiment of the present disclosure. In describing various embodiments consistent with the present disclosure, reference may be made to technologies such as, for example, LED lighting, Bluetooth wireless communications, etc. These examples have been utilized to provide a readily comprehensible perspective for understanding the disclosed embodiments, and are not intended to limit implementations to only using these technologies, etc. Moreover, the inclusion of an apostrophe after an item number in a drawing figure (e.g., 100′) is to indicate that an example embodiment of the item is being illustrated. The example embodiments are not intended to limit the disclosure to only what is shown, and are presented merely for the sake of explanation.

Example system 100 is illustrated in FIG. 1. System 100 may comprise at least one device 102. Device 102 is represented in FIG. 1 as being a lightbulb replacement-type device wherein device 102 may include a connector 104 (e.g., an Edison screw (ES) connector such as an E27 screw base commonly used in the United States) that may screw into a light socket to replace, for example, an existing incandescent bulb. However, the depicted configuration is merely an example implementation. Consistent with the present disclosure, other example implementation may comprise different electrical connectors (e.g., other screw bases, bayonet bases, flanged bases, slide bases, wedge bases, pin bases, etc.), entire light fixtures including a light source that plug into an electrical socket or are hardwired into an electrical system, etc.

Device 102 may comprise, for example, at least lighting circuitry 106, audio circuitry 108 and sensing circuitry 110. Lighting circuitry 106 may comprise any type of electric light source, but more commonly includes one or more LED light sources and supporting circuitry. Audio circuitry may comprise at least one sound generation component (e.g., speaker) along with supporting circuitry to, for example, convert digital audio data into analog sound signals, modify and/or filter the analog sound signals, amplify the analog sound signals, etc. Sensing circuitry 110 may comprise at least one sensor to determine that a user is proximate to device 102 and supporting circuitry. The at least one sensor may employ electronic sensing (e.g., an inductive or capacitive sensor), visual sensing technology (e.g., a camera), audible sensing technology (e.g., a microphone), magnetic sensing technology (e.g., Hall Effect sensor), electromagnetic sensing (e.g., infrared), etc. Proximity may also be determined by a wireless link being established between device 102 and a source device in the possession of the user. For example, since Bluetooth has a limited range, a connection between device 102 and the source device may indicate that the user is at least within Bluetooth range of device 102.

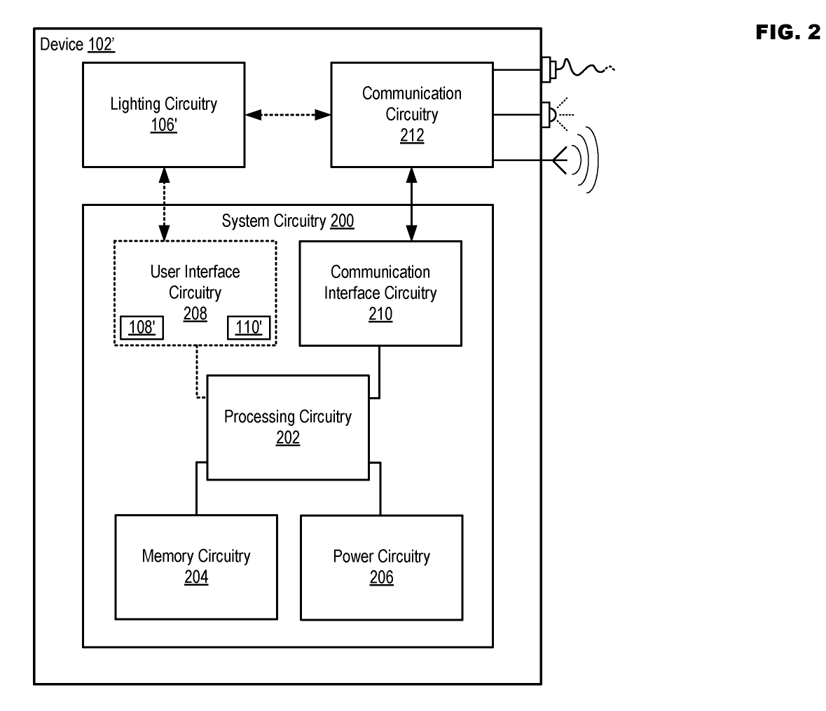

Device 102 may generate light 112, sound 114 and may sense for a proximate user as shown at 116. These activities may occur individually or in combination. The characteristics (e.g., range, shape of the dispersion/sensing field, light color and intensity, frequency range, tone, etc.) of these activities may depend on the makeup and configuration of circuitry 106 to 110. In at least one embodiment, device 102 may also include control circuitry to control the operation of circuitry 106 to 110. An example of the control circuitry is described in detail in regard to FIG. 2. The control circuitry may be implemented in any or all of circuitry 106 to 100, or in another separate location within device 102.

In an example of operation, system 100 may comprise multiple devices 102 including, for example, device 102A, device 102B, device 102C, device 102D, device 102E and device 102F (collectively, “devices 102A . . . F”) installed in ceiling 118. While six devices 102A . . . F are shown, this number may vary depending on the particular implementation, the abilities of devices 102A . . . F, the use for which system 100 is designed, etc. In one mode of operation, device 102A may simply detect the presence of a proximate user as shown at 120, and may at least enable audio circuitry 108 to generate sound 114′ based on audio data (e.g., prerecorded or live sound including music, a video soundtrack, a presentation, etc.) received from source device 122. Examples of source device 122 may include, but are not limited to, a mobile communication device such as a cellular handset or a smartphone based on the Android® OS from the Google Corporation, iOS® or Mac OS® from the Apple Corporation, Windows® OS from the Microsoft Corporation, Linux® OS, Tizen® OS and/or other similar operating systems that may be deemed derivatives of Linux® OS from the Linux Foundation, Firefox® OS from the Mozilla Project, Blackberry® OS from the Blackberry Corporation, Palm® OS from the Hewlett-Packard Corporation, Symbian® OS from the Symbian Foundation, etc., a mobile computing device such as a tablet computer like an iPad® from the Apple Corporation, Surface® from the Microsoft Corporation, Galaxy Tab® from the Samsung Corporation, Kindle® from the Amazon Corporation, etc., an Ultrabook® including a low-power chipset from the Intel Corporation, a netbook, a notebook, a laptop, a palmtop, etc., a wearable device such as a wristwatch form factor computing device like the Galaxy Gear® from Samsung, Apple Watch® from the Apple Corporation, etc., an eyewear form factor computing device/user interface like Google Glass® from the Google Corporation, a virtual reality (VR) headset device like the Gear VR® from the Samsung Corporation, the Oculus Rift® from the Oculus VR Corporation, etc., a typically stationary computing device such as a desktop computer, a server, a group of computing devices organized in a high performance computing (HPC) architecture, a smart television or other type of “smart” device, small form factor computing solutions (e.g., for space-limited applications, TV set-top boxes, etc.) like the Next Unit of Computing (NUC) platform from the Intel Corporation, etc. The audio data may be received at device 102A via wired or wireless communication. Device 102A may continue to generate sound based on the audio data until, for example, sensing circuitry 110 detects that the user is no longer proximate to device 102A. Device 102A may then at least discontinue generating sound 114′ based on the audio data.

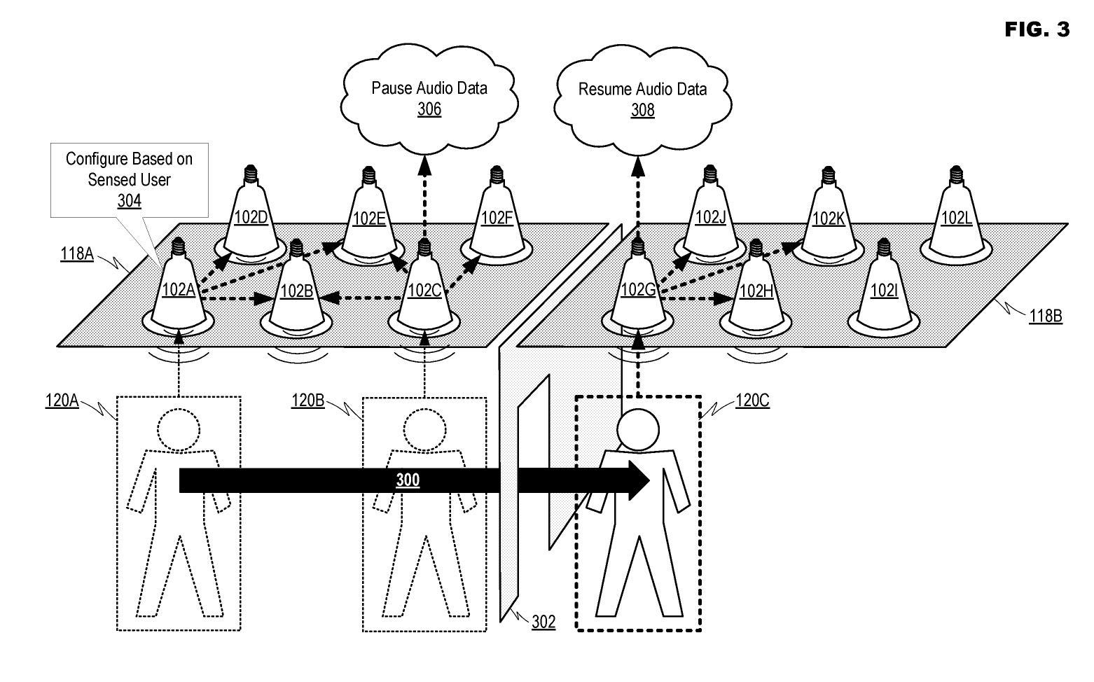

Consistent with the present disclosure, device 102A may further interact with devices 102B . . . F to coordinate sound production. For example, a group may be established through user configuration of devices 102A . . . F (e.g., through an external user interface such as an application executed on device 122). In the example of FIG. 1, device 102A may determine that a user is proximate at 120 and may interact with device 102B, 102D and 102E to cause these devices to generate sound based on the received audio data. Device 102A may provide the audio data to devices 102B, 102D and 102E, or devices 102B, 102D and 102E may each obtain the audio data directly from source device 122. Using more than one device 102A . . . F in a group for sound generation may facilitate different audio effects such as stereo sound, quadriphonic sound, spatial (e.g., immersive) sound, etc. The type of sound generation used may depend on, for example, user configuration, the content of the audio data, etc. In at least one embodiment, any of devices 102A, 102B, 102D and 102E sensing a proximate user (e.g., as shown at 120) may continue operation of the group in that sound generation based on the audio data may continue through devices 102A, 102B, 102D and 102E. Alternatively, any of devices 102A . . . F sensing the presence of a user as shown at 120 may cause the activation of another group defined in devices 102A . . . F, cause all devices 102A . . . F to be activated, etc. Other example modes of operation consistent with the present disclosure are shown in FIG. 3.

FIG. 2 illustrates an example configuration for a device usable in accordance with at least one embodiment of the present disclosure. For example, device 102′ may be able to perform any or all of the activities shown in FIG. 1. However, device 102′ is presented only as an example of an apparatus usable in embodiments consistent with the present disclosure, and is not intended to limit any of the embodiments to a particular manner of implementation.

System circuitry 200 may manage the operation of device 102′. System circuitry 200 may include, for example, processing circuitry 202, memory circuitry 204, power circuitry 206, user interface circuitry 208 and communication interface circuitry 210. Device 102′ may also include communication circuitry 212 and lighting circuitry 106′. While communication circuitry 212 and lighting circuitry 106′are shown as separate from system circuitry 200, the example configuration illustrated in FIG. 2 has been provided merely for the sake of explanation. Some or all of the functionality associated with communication circuitry 212 and lighting circuitry 106′ may also be incorporated into system circuitry 200.

In device 102′, processing circuitry 202 may comprise one or more processors situated in separate components, or alternatively one or more processing cores in a single component (e.g., in a System-on-a-Chip (SoC) configuration), along with processor-related support circuitry (e.g., bridging interfaces, etc.). Example processors may include, but are not limited to, various x86-based microprocessors available from the Intel Corporation including those in the Pentium, Xeon, Itanium, Celeron, Atom, Quark, Core i-series, Core M-series product families, Advanced RISC (e.g., Reduced Instruction Set Computing) Machine or “ARM” processors, etc. Examples of support circuitry may include chipsets (e.g., Northbridge, Southbridge, etc. available from the Intel Corporation) configured to provide an interface through which processing circuitry 202 may interact with other system components that may be operating at different speeds, on different buses, etc. in device 102′. Moreover, some or all of the functionality commonly associated with the support circuitry may also be included in the same physical package as the processor (e.g., such as in the Sandy Bridge family of processors available from the Intel Corporation).

Processing circuitry 202 may be configured to execute various instructions in device 102′. Instructions may include program code configured to cause processing circuitry 202 to perform activities related to reading data, writing data, processing data, formulating data, converting data, transforming data, etc. Information (e.g., instructions, data, etc.) may be stored in memory circuitry 204. Memory circuitry 204 may comprise random access memory (RAM) and/or read-only memory (ROM) in a fixed or removable format. RAM may include volatile memory configured to hold information during the operation of device 102′ such as, for example, static RAM (SRAM) or Dynamic RAM (DRAM). ROM may include non-volatile (NV) memory circuitry configured based on BIOS, UEFI, etc. to provide instructions when device 102′ is activated, programmable memories such as electronic programmable ROMs (EPROMS), Flash, etc. Other fixed/removable memory may include, but are not limited to, magnetic memories such as, for example, floppy disks, hard drives, etc., electronic memories such as solid state flash memory (e.g., embedded multimedia card (eMMC), etc.), removable memory cards or sticks (e.g., micro storage device (uSD), USB, etc.), optical memories such as compact disc-based ROM (CD-ROM), Digital Video Disks (DVD), Blu-Ray Disks, etc.

Power circuitry 206 may include internal power sources (e.g., a battery, fuel cell, etc.) and/or external power sources (e.g., electromechanical or solar generator, power grid, external fuel cell, etc.), and related circuitry configured to supply device 102′ with the power needed to operate. User interface circuitry 208 may include hardware and/or software to allow users to interact with device 102′ such as, for example, various input mechanisms (e.g., microphones, switches, buttons, knobs, keyboards, speakers, touch-sensitive surfaces, one or more sensors configured to capture images and/or sense proximity, distance, motion, gestures, orientation, biometric data, etc.) and various output mechanisms (e.g., speakers, displays, lighted/flashing indicators, electromechanical components for vibration, motion, etc.). The hardware in user interface circuitry 208 may be incorporated within device 102′ and/or may be coupled to device 102′ via a wired or wireless communication medium. Some user interface circuitry 208 may be optional in certain circumstances such as, for example, a situation wherein device 102′ is a small device (e.g., a light bulb form factor device), a server (e.g., rack server or blade server), etc. that does not include user interface circuitry 208, and instead relies on another device (e.g., a management terminal) for user interface functionality.

Communication interface circuitry 210 may be configured to manage packet routing and other control functions for communication circuitry 212, which may include resources configured to support wired and/or wireless communications. In some instances, device 102′ may comprise more than one set of communication circuitry 212 (e.g., including separate physical interface circuitry for wired protocols and/or wireless radios) managed by centralized communication interface circuitry 210. Wired communications may include serial and parallel wired mediums such as, for example, Ethernet, USB, Firewire, Thunderbolt, Digital Video Interface (DVI), High-Definition Multimedia Interface (HDMI), etc. Wireless communications may include, for example, close-proximity wireless mediums (e.g., radio frequency (RF) such as based on the RF Identification (RFID)or Near Field Communications (NFC) standards, infrared (IR), etc.), short-range wireless mediums (e.g., Bluetooth, WLAN, Wi-Fi, etc.), long range wireless mediums (e.g., cellular wide-area radio communication technology, satellite-based communications, etc.), electronic communications via sound waves, etc. In one embodiment, communication interface circuitry 210 may be configured to prevent wireless communications that are active in communication circuitry 212 from interfering with each other. In performing this function, communication interface circuitry 210 may schedule activities for communication circuitry 212 based on, for example, the relative priority of messages awaiting transmission. While the embodiment disclosed in FIG. 2 illustrates communication interface circuitry 210 being separate from communication circuitry 212, it may also be possible for the functionality of communication interface circuitry 210 and communication circuitry 212 to be incorporated into the same circuitry.

Consistent with the present disclosure, at least processing circuitry 202 may perform control operations within device 102′. For example, processing circuitry 202 may interact with memory circuitry 204 to load an operating system, drivers, utilities, applications, etc. to support operation of device 102.′ Execution of the software may transform general purpose processing circuitry 202 into specialized circuitry to perform the activities described herein. For example, processing circuitry 202 may receive sensor data from sensing circuitry 110′in user interface circuitry 208. If the sensor data indicates a proximate user, then processing circuitry 202 may cause communication circuitry 212 to at least received audio data from source device 122. In at least one embodiment, processing circuitry 202 may also cause communication circuitry 212 to transmit one or more messages to other devices in a group with device 102′. After receiving the audio data via communication circuitry 212, processing circuitry 202 may at least cause audio circuitry 108′ to generate sound using the audio data. Lighting circuitry 106′ may be independently controlled (e.g., via a switch in user interface circuitry 208, via control signals received through communication circuitry 212, etc.) or may be controlled by processing circuitry 202. For example, the presence of a user proximate to device 102′ may cause processing circuitry 202 to control the operation of lighting circuitry 106′ to turn on/off light 112, set characteristics for light 112 (e.g., color, intensity, etc.), etc.

FIG. 3 illustrates an example functionality that may be performed within a system including sound generation devices with proximity control features in accordance with at least one embodiment of the present disclosure. FIG. 3 builds upon the simple example of FIG. 1 in that a user that is moving along a path 300 from a first area to a second area (e.g., separated by wall 302) may be sensed at multiple locations 120A, 120B and 120C. The user may first be sensed in proximity to device 102A as shown at 120A, which may cause device 102A to generate sound by itself or in combination with devices 102B, 102D and 102E that are grouped with device 102A.

In at least one embodiment, sensing a user in proximity to any device 102A . . . F may further comprise determining an identity of the user and configuring one or more of devices 102A . . . F based on the user identity as shown at 304. For example, the user may be carrying a mobile device (e.g., smart phone, tablet computer, etc.). When the user enters into wireless communication range of devices 102A . . . F (e.g., Bluetooth wireless communication range), a wireless link may be established. The device carried by the user may link to device 102A, which may identify the user based on user identification (ID), device ID, etc. Alternatively, characteristic features of a user (e.g., biometric data) may be sensed by device 102A and used to identify the user. For example, device 102A may be capable of capturing visual data (e.g., with a camera) that may include an image of the user's face. Facial recognition may then be utilized to identify the user. Other types of biometric data may also be employed, alone or in combination, to identify the user. A configuration corresponding to the identified user may be stored in at least device 102A (e.g., configured utilizing an external user interface such as provided in an application executed in source device 122), may be configured within device 122 (e.g., by the user) and then transmitted to device 102A via wireless communication, etc. An example configuration may establish preferred audio playback volume, tone settings, mode (e.g., stereo, surround, etc.), light settings such as on/off, intensity, color, etc. The configuration may also dictate how audible and/or visible notifications are to be presented to the user. For example, if device 122 is a mobile device, tablet device, etc., the configuration may dictate that alarm tones for incoming calls, emails, message social media alerts, etc. are to be played only on device 102A (e.g., only on the speaker closest to the user), on all of the devices in the group controlled by 102A, are to cause a light or lights to react (e.g., blink in a pattern), etc. In this manner, notifications may be directed to the current location of the user. Device 102A may also communicate either the user ID (e.g., from which the configuration may be determined) or the configuration to other devices in the group (e.g., devices 102B, 102D and 102E) so that the other devices in the group may be appropriately configured.

As the user follows path 300 other devices 102A . . . F and/or groups may be activated. For example, device 102C sensing the user as shown at 120B may cause a group that further includes devices 102B, 102E and 102F to become active. In at least one embodiment, it may further be possible for devices 102A . . . F to sense certain conditions indicative of the behavior of the user and to perform certain actions based on the sensed conditions. An example first condition may involve a user exiting an area corresponding to ceiling installation 118A and entering a second area corresponding to ceiling installation 118B (e.g., by walking through a door in wall 302. Upon sensing user movement, acceleration, direction, a pattern of travel of the user (e.g., the user was sensed by device 102B at 120A and is then sensed at device 102C at 120B, indicating an approximate path of travel for the user), device 102C may transmit a message to a source of the audio data (e.g., source device 122) to cause the device to pause transmission and/or playback of the audio data as shown at 306. When the user arrives in the second area corresponding to ceiling installation 118B (e.g., as shown at 120C), device 102G may sense that the user is nearby and may cause the source to resume audio data transmission and/or playback as shown at 308. Device 102G may then proceed to enable sound generation based on the audio data. In addition, the second area may further comprise device 102H, device 1021, device 102J, device 102K and device 102L (collectively, “devices 102G . . . L”). Device 102G may also cause devices in its group including, for example, device 102H, 102J and 102K to enable sound generation based on the audio data (e.g., either with or without a user configuration). While the two areas are illustrated as different rooms in FIG. 3, it may also be possible for this type of operation to occur when a user transitions to a vehicle (e.g., the audio data transmission and/or playback may be paused until the user is situated in the car and resumes through the car audio system). Moreover, another example where transmission and/or playback of audio data may be paused is when the user is performing another activity. For example, if the user is on a telephone call, then transmission and/or playback of the audio data may be paused. This may be signaled by, for example, a Bluetooth message transmitted from a mobile device (e.g., a cellular phone) to any of devices 102A . . . F. The transmission and/or playback of the audio data may then resume after the call is complete (e.g., which may be signaled by another Bluetooth message). This would prevent the user from missing any of the audio playback when moving between different areas, engaged in other activities, etc.

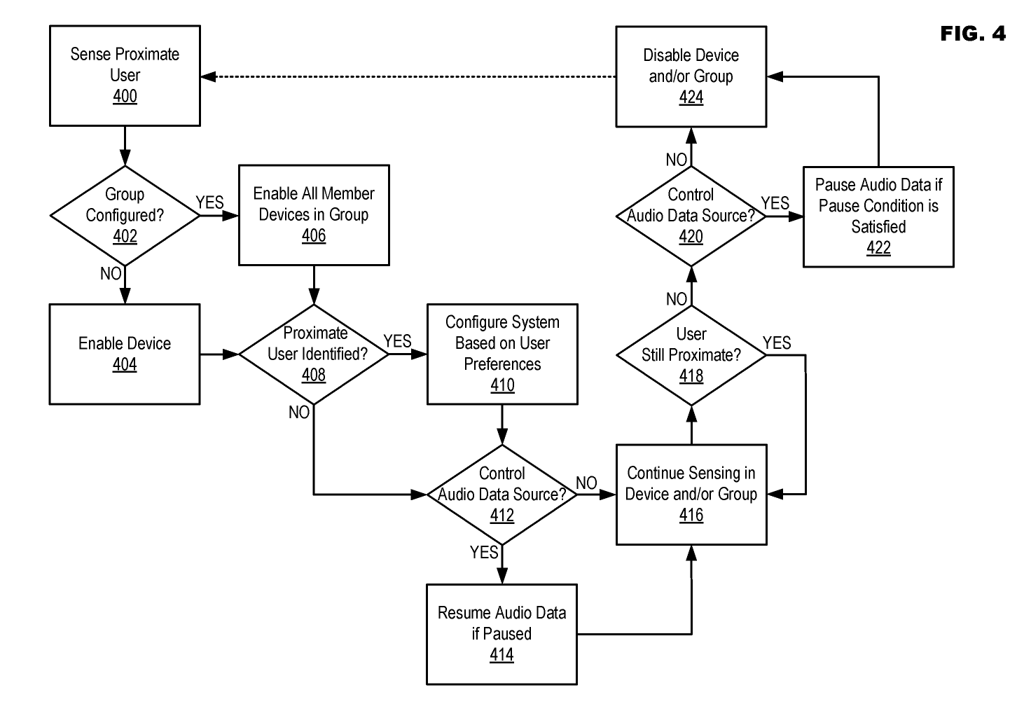

FIG. 4 illustrates example operations controlling sound generation in a device based on proximity in accordance with at least one embodiment of the present disclosure. A device may sense a proximate user in operation 400. A determination may be made in operation 402 as to whether a group has been configured including at least the device. Whether a group is configured may depend on, for example, the number of devices that are installed, the abilities of the devices, etc. If in operation 402 it is determined that a group is not configured, then in operation 404 the audio circuitry in the device may be enabled. Alternatively, if in operation 402 it is determined that a group has been configured, then the audio circuitry in all devices that are members of the group may be enabled in operation 406. Following operations 404 or 406 a further determination may be made as to whether the user that was sensed proximate to the device has been identified. User identification may depend on, for example, whether the user identification functionality is available, whether the user is identifiable (e.g., whether a device or characteristic features can be sensed), whether a configuration has been established for the user, etc. If the user was identified, then in operation 410 the system (e.g., including the device or group) may be configured based on user preferences set for the identified user.

A determination in operation 408 that identification of the user was not possible, or alternatively operation 410, may be followed by operation 412 wherein a determination may be made as to whether the audio data source is being controlled. Control over the audio data source may involve pausing or resuming the audio data transmission and/or playback based on the occurrence of certain conditions. If in operation 412 it is determined that control over the audio data source is being performed, then the sensing of a user proximate to the device may trigger a transmission to the audio data source to resume transmission and/or playback of the audio data. A determination in operation 412 that audio data source control is not being conducted, or alternatively operation 414, may be followed by operation 416 wherein sensing for the user may continue in the device or group (e.g., in one or more devices in the group). Sensing may continue in operation 416 until it is determined in operation 418 that the user is no longer proximate to the device or group. A determination may then be made in operation 420 as to whether the audio data source is controlled. If in operation 420 it is determined that audio data source control is implemented, then in operation 422 transmission and/or playback of the audio data may be paused if a certain condition has been satisfied. Example conditions may include, but are not limited to, the user departing from an area corresponding to at least one device that is generating sound based on the audio data, initiating a certain activity that is being monitored by at least one device that is generating sound based on the audio data, etc. A determination in operation 420 that audio data source control is not being conducted, or alternatively operation 422, may be followed by operation 424 wherein the audio circuity in the device or group may be disabled. Operation 424 may optionally be followed by a return to operation 400 to resume sensing for proximate users.

While FIG. 4 illustrates operations according to an embodiment, it is to be understood that not all of the operations depicted in FIG. 4 are necessary for other embodiments. Indeed, it is fully contemplated herein that in other embodiments of the present disclosure, the operations depicted in FIG. 4, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the terms “system” or “module” may refer to, for example, software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums (e.g., non-transitory storage mediums) having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

Thus, the present disclosure pertains to a sound generation device with proximity control. In general, a device may include sound generation functionality that may be controlled based on proximity sensing. The device may be, for example, a lighting device including circuitry to generate sound based on audio data received from a source outside of the device. Sensing circuitry in the device may generate sensor data that indicates when a user is proximate to the device. Control circuitry in the device may then control the sound generation based on sensor data. Various operations in the device may be based on the sensor data indicating that a user is proximate to the device, the identity of the user, that a certain condition has occurred, etc.

The following examples pertain to further embodiments. The following examples of the present disclosure may comprise subject material such as a sound generation device with proximity control features, a method, at least one machine-readable medium for storing instructions that when executed cause a machine to perform acts based on the method, means for performing acts based on the method and/or a system including at least the device.

According to example 1 there is provided a sound generation device. The device may comprise communication circuitry to receive at least audio data, audio circuitry to generate sound based on the received audio data, sensing circuitry to generate sensor data based on proximity sensing and control circuitry to control at least the audio circuitry based on the sensor data.

Example 2 may include the elements of example 1, and may further comprise lighting circuitry to generate light, the lighting circuitry also being controlled by the control circuitry.

Example 3 may include the elements of example 2, and may further comprise a connector for electrically coupling the device to a light socket to receive power for operating the device.

Example 4 may include the elements of example 3, wherein the coupling is an Edison connector.

Example 5 may include the elements of any of examples 2 to 3, wherein the control circuitry is to cause at least one of the audio circuitry or the lighting circuitry to present at least one of audible or visible notifications.

Example 6 may include the elements of any of examples 1 to 5, wherein the control circuitry is to cause the audio circuitry to generate the sound when the sensor data indicates that the user is proximate to the device.

Example 7 may include the elements of example 6, wherein the sensing circuitry is to sense that the user is proximate to the device based on at least one of the proximity or motion of the user.

Example 8 may include the elements of any of examples 6 to 7, wherein the sensing circuitry is to sense that the user is proximate to the device based on sensing the presence of a source device in possession of the user.

Example 9 may include the elements of any of examples 6 to 8, wherein the control circuitry is to cause at least the communication circuitry to interact with other devices to cause the other devices to generate the sound.

Example 10 may include the elements of example 9, wherein the device and other devices constitute a group of devices, all of the devices in the group being caused to generate the sound when at least one of the devices determines that the user is proximate.

Example 11 may include the elements of any of examples 9 to 10, wherein the control circuitry is to at least one of cause the audio circuitry to discontinue sound generation when the sensor data indicates that the user is no longer proximate to the device or cause the communication circuitry to interact with the other devices to cause the other devices to discontinue sound generation.

Example 12 may include the elements of any of examples 6 to 11, wherein the control circuitry is to determine an identity of the user and configure at least the audio circuitry based on the determined identity of the user.

Example 13 may include the elements of example 12, wherein the control circuitry determines the identity of the user based on the sensor data including biometric data for identifying the user.

Example 14 may include the elements of any of examples 12 to 13, wherein the control circuitry determines the identity of the user based on data received from a source device in possession of the user.

Example 15 may include the elements of any of examples 12 to 14, wherein the audio circuitry is configured based on user preferences corresponding to the identified user.

Example 16 may include the elements of any of examples 12 to 15, wherein lighting circuitry in the device is also configured based on the determined identity of the user.

Example 17 may include the elements of any of examples 6 to 16, wherein the control circuitry is to cause the communication circuitry to interact with a source of the audio data to cause the source to pause at least one of playback or transmission of the audio data based on a first condition being satisfied.

Example 18 may include the elements of example 17, wherein the control circuitry is to cause the communication circuitry to interact with the source to cause the source to resume at least one of the paused playback or transmission of the audio data based on a second condition being satisfied.

Example 19 may include the elements of example 18, wherein the first condition includes the user leaving an area corresponding to the device and the second condition includes the user entering the area.

Example 20 may include the elements of any of examples 18 to 19, wherein the first condition includes the user initiating an activity on a source device and the second condition includes the user concluding the activity.

Example 21 may include the elements of any of examples 1 to 20, wherein the control circuitry is to at least one of cause the audio circuitry to generate the sound when the sensor data indicates that the user is proximate to the device, or cause at least the communication circuitry to interact with other devices to cause the other devices to generate the sound.

According to example 22 there is provided a method for controlling sound generation in a device based on proximity The method may comprise sensing a user in proximity to a device, generating sensor data based on the sensing, receiving at least audio data in the device, enabling sound generation in the device based at least on the sensor data and causing the device to generate sound based at least one the audio data.

Example 23 may include the elements of example 22, and may further comprise causing the device to generate light.

Example 24 may include the elements of any of examples 22 to 23, and may further comprise causing the device to generate the sound when the sensor data indicates that a user is proximate to the device.

Example 25 may include the elements of example 24, and may further comprise causing the device to interact with other devices to cause the other devices to generate the sound.

Example 26 may include the elements of example 25, and may further comprise at least one of causing the device to discontinue sound generation when the sensor data indicates that the user is no longer proximate to the device, or causing the device to interact with the other devices to cause the other devices to discontinue sound generation.

Example 27 may include the elements of any of examples 24 to 26, and may further comprise determining an identity of the user and configuring the device based on the determined identity of the user.

Example 28 may include the elements of any of examples 24 to 27, and may further comprise causing the device to interact with a source of the audio data to cause the source to pause at least one of playback or transmission of the audio data based on a first condition being satisfied, and causing the device to interact with the source to cause the source to resume at least one of the paused playback or transmission of the audio data based on a second condition being satisfied.

Example 29 may include the elements of example 28, wherein the first condition includes the user leaving an area corresponding to the device or initiating an activity on a source device and the second condition includes the user entering the area or concluding the activity.

Example 30 may include the elements of any of examples 22 to 29, and may further comprise at least one of causing the device to generate the sound when the sensor data indicates that a user is proximate to the device, or causing the device to interact with other devices to cause the other devices to generate the sound.

Example 31 may include the elements of any of examples 22 to 30, and may further comprise causing the device to present audible or visible notifications.

According to example 32 there is provided a system including at least one device, the system being arranged to perform the method of any of the above examples 22 to 31.

According to example 33 there is provided a chipset arranged to perform the method of any of the above examples 22 to 31.

According to example 34 there is provided at least one machine readable medium comprising a plurality of instructions that, in response to be being executed on a computing device, cause the computing device to carry out the method according to any of the above examples 22 to 31.

According to example 35 there is provided a device capable of controlling at least sound generation in the device, the device being arranged to perform the method of any of the above examples 22 to 31.

According to example 36 there is provided a system for controlling sound generation in a device based on proximity The system may comprise means for sensing a user in proximity to a device, means for generating sensor data based on the sensing, means for receiving at least audio data in the device, means for enabling sound generation in the device based at least on the sensor data and means for causing the device to generate sound based at least one the audio data.

Example 37 may include the elements of example 36, and may further comprise means for causing the device to generate light.

Example 38 may include the elements of any of examples 36 to 37, and may further comprise means for causing the device to generate the sound when the sensor data indicates that a user is proximate to the device.

Example 39 may include the elements of example 38, and may further comprise means for causing the device to interact with other devices to cause the other devices to generate the sound.

Example 40 may include the elements of example 39, and may further comprise at least one of means for causing the device to discontinue sound generation when the sensor data indicates that the user is no longer proximate to the device, or means for causing the device to interact with the other devices to cause the other devices to discontinue sound generation.

Example 41 may include the elements of any of examples 38 to 40, and may further comprise means for determining an identity of the user and means for configuring the device based on the determined identity of the user.

Example 42 may include the elements of any of examples 38 to 41, and may further comprise means for causing the device to interact with a source of the audio data to cause the source to pause at least one of playback or transmission of the audio data based on a first condition being satisfied and means for causing the device to interact with the source to cause the source to resume at least one of the paused playback or transmission of the audio data based on a second condition being satisfied.

Example 43 may include the elements of example 42, wherein the first condition includes the user leaving an area corresponding to the device or initiating an activity on a source device and the second condition includes the user entering the area or concluding the activity.

Example 44 may include the elements of any of examples 36 to 43, and may further comprise at least one of means for causing the device to generate the sound when the sensor data indicates that a user is proximate to the device or means for causing the device to interact with other devices to cause the other devices to generate the sound.

Example 45 may include the elements of any of examples 36 to 44, and may further comprise means for causing the device to present audible or visible notifications.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1-25. (canceled)

26. A sound generation device, comprising:
communication circuitry to receive at least audio data;
audio circuitry to generate sound based on the received audio data;
sensing circuitry to generate sensor data based on proximity sensing; and
control circuitry to control at least the audio circuitry based on the sensor data.

27. The device of claim 26, further comprising lighting circuitry to generate light, the lighting circuitry also being controlled by the control circuitry.

28. The device of claim 27, further comprising a connector for electrically coupling the device to a light socket to receive power for operating the device.

29. The device of claim 26, wherein the control circuitry is to cause the audio circuitry to generate the sound when the sensor data indicates that the user is proximate to the device.

30. The device of claim 29, wherein the control circuitry is to cause at least the communication circuitry to interact with other devices to cause the other devices to generate the sound.

31. The device of claim 30, wherein the device and other devices constitute a group of devices, all of the devices in the group being caused to generate the sound when at least one of the devices determines that the user is proximate.

32. The device of claim 30, wherein the control circuitry is to at least one of cause the audio circuitry to discontinue sound generation when the sensor data indicates that the user is no longer proximate to the device or cause the communication circuitry to interact with the other devices to cause the other devices to discontinue sound generation.

33. The device of claim 29, wherein the control circuitry is to determine an identity of the user and configure at least the audio circuitry based on the determined identity of the user.

34. The device of claim 29, wherein the control circuitry is to cause the communication circuitry to interact with a source of the audio data to cause the source to pause at least one of playback or transmission of the audio data based on a first condition being satisfied.

35. The device of claim 33, wherein the control circuitry is to cause the communication circuitry to interact with the source to cause the source to resume at least one of the paused playback or transmission of the audio data based on a second condition being satisfied.

36. The device of claim 35, wherein the first condition includes at least one of the user leaving an area corresponding to the device and the second condition includes the user entering the area or the user initiating an activity on a source device and the second condition includes the user concluding the activity.

37. A method for controlling sound generation in a device based on proximity, comprising:
sensing a user in proximity to a device;
generating sensor data based on the sensing;
receiving at least audio data in the device;
enabling sound generation in the device based at least on the sensor data; and
causing the device to generate sound based at least one the audio data.

38. The method of claim 37, further comprising:
causing the device to generate light.

39. The method of claim 37, further comprising:
causing the device to generate the sound when the sensor data indicates that a user is proximate to the device.

40. The method of claim 39, further comprising:
causing the device to interact with other devices to cause the other devices to generate the sound.

41. The method of claim 40, further comprising at least one of:
causing the device to discontinue sound generation when the sensor data indicates that the user is no longer proximate to the device; or
causing the device to interact with the other devices to cause the other devices to discontinue sound generation.

42. The method of claim 39, further comprising:
determining an identity of the user; and
configuring the device based on the determined identity of the user.

43. The method of claim 39, further comprising:
causing the device to interact with a source of the audio data to cause the source to pause at least one of playback or transmission of the audio data based on a first condition being satisfied; and
causing the device to interact with the source to cause the source to resume at least one of the paused playback or transmission of the audio data based on a second condition being satisfied.

44. At least one machine-readable storage medium having stored thereon, individually or in combination, instructions for controlling sound generation in a device based on proximity that, when executed by one or more processors, cause the one or more processors to:
sense a user in proximity to a device;
generate sensor data based on the sensing;
receive at least audio data in the device;
enable sound generation in the device based at least on the sensor data; and
cause the device to generate sound based at least one the audio data.

45. The storage medium of claim 44, further comprising instructions that, when executed by one or more processors, cause the one or more processors to:
cause the device to generate light.

46. The storage medium of claim 44, further comprising instructions that, when executed by one or more processors, cause the one or more processors to:
cause the device to generate the sound when the sensor data indicates that a user is proximate to the device.

47. The storage medium of claim 46, further comprising instructions that, when executed by one or more processors, cause the one or more processors to:
cause the device to interact with other devices to cause the other devices to generate the sound.

48. The storage medium of claim 47, further comprising instructions that, when executed by one or more processors, cause the one or more processors to at least one of:
cause the device to discontinue sound generation when the sensor data indicates that the user is no longer proximate to the device or
cause the device to interact with the other devices to cause the other devices to discontinue sound generation.

49. The storage medium of claim 46, further comprising instructions that, when executed by one or more processors, cause the one or more processors to:
determine an identity of the user; and
configure the device based on the determined identity of the user.

50. The storage medium of claim 46, further comprising instructions that, when executed by one or more processors, cause the one or more processors to:
cause the device to interact with a source of the audio data to cause the source to pause at least one of playback or transmission of the audio data based on a first condition being satisfied; and
cause the device to interact with the source to cause the source to resume at least one of the paused playback or transmission of the audio data based on a second condition being satisfied.
